(19) United States
(12) Patent Application Publication
(10) Pub. No.: US 2023/0047896 A1
(43) Pub. Date: Feb. 16, 2023

(54) TEMPERATURE DETECTION CIRCUIT

(71) Applicant: Mitsubishi Electric Corporation, Tokyo (JP)

(72) Inventors: Yasutaka IMAMURA, Chiyoda-ku, Tokyo (JP); Yohei MITSUI, Chiyoda-ku, Tokyo (JP); Junichi NAKASHIMA, Chiyoda-ku, Tokyo (JP)

(73) Assignee: Mitsubishi Electric Corporation, Tokyo (JP)

(21) Appl. No.: 17/793,938

(22) PCT Filed: Apr. 3, 2020
(86) PCT No.: PCT/JP2020/015280

§ 371 Date: Jul. 20, 2022

(51) Int. Cl. G01K 7/22

(52) U.S. Cl. CPC G01K 7/22; G01K 2215/00

(57) ABSTRACT

This temperature detection circuit includes: a temperature sensor having a resistance value that changes according to a change in temperature; an AC power supply that supplies AC power to the temperature sensor; a resonance circuit connected to the temperature sensor, the resonance circuit having an impedance that has an extreme value when AC power having a resonance frequency is supplied; and a voltage detection circuit that detects a voltage applied to any of a plurality of elements connected to the AC power supply. The resonance frequency in the resonance circuit and the frequency of the AC power are set to coincide with each other.

### TECHNICAL FIELD

The present disclosure relates to a temperature detection circuit.

### BACKGROUND ART

As a temperature detection circuit, a configuration including a thermistor as a temperature sensor, for example, is known. In this temperature detection circuit, the temperature of the thermistor can be detected by applying a voltage to the thermistor using a DC power supply or an AC power supply and measuring the resistance value of the thermistor. For example, Japanese Patent Laying-Open No. 62-291558 (Patent Literature 1) discloses a temperature detection circuit including a thermistor used for temperature compensation of a humidity sensor and configured to be able to detect a temperature by power supply from an AC power supply.

### CITATION LIST

### Patent Literature

PTL 1: Japanese Patent Laying-Open No. 62-291558

### SUMMARY OF INVENTION

### Technical Problem

The temperature detection circuit including a temperature sensor such as a thermistor as described above may be mounted on. for example, a power semiconductor such as a power conversion device that performs a switching operation at the time of power conversion. It is know n that strong electromagnetic noise is generated when the power semiconductor performs a switching operation. In order to improve the noise tolerance of the temperature detection circuit with respect to the electromagnetic noise, it is conceivable to increase the power supply voltage, for example.

However, when the power supply voltage is increased, a temperature rise due to self-heating of the temperature sensor increases, which may cause an increase in error of the detection temperature by the detection circuit. This is because the power consumption in the temperature sensor increases by increasing the power supply voltage, and an amount of temperature rise due to self-heating of the temperature sensor increases.

The present disclosure has been accomplished to solve the above-described problems, and an object of the present disclosure is to provide a temperature detection circuit that suppresses an increase in a temperature detection error caused by self-heating of a temperature sensor.

### Solution to Problem

The present disclosure relates to a temperature detection circuit. The temperature detection circuit includes: a temperature sensor having a resistance value that changes according to a change in temperature; an AC power supply to supply AC power to the temperature sensor; a resonance circuit connected to the temperature sensor, the resonance circuit having an impedance that has an extreme value when AC power having a resonance frequency is supplied; and a voltage detection circuit to detect a voltage applied to any one of a plurality of elements connected to the AC power supply and detect a temperature of the temperature sensor using the detected voltage. The resonance frequency in the resonance circuit and the frequency of the AC power are set to coincide with each other.

### Advantageous Effects of Invention

According to the present disclosure, when the impedance has, for example, a minimum value at the resonance frequency, it is possible to suppress the influence of a noise component on the detection result even when the noise component in a frequency band other than the resonance frequency is superimposed on the output of the temperature sensor. As a result, the noise tolerance can he increased without increasing the output voltage of the AC power. Furthermore, since it is not required to increase the output voltage of the NC power, an increase in error caused by sells-heating of the temperature sensor can he suppressed.

### BRIEF DESCRIPTION OF DRAWINGS

FIG. 1 is a circuity diagram illustrating a configuration of a temperature detection circuit according to a first embodiment.

FIG. 2 is a circuit diagram illustrating a configuration of a temperature detection circuit according to a comparative example with respect to the first embodiment.

FIG. 3 is a circuit diagram illustrating a configuration of an inverter equipped with a temperature detection circuit according to a second embodiment.

FIG. 4 is a diagram for describing the operation of the inverter of the second embodiment.

FIG. 5 is a. diagram illustrating a frequency spectrum of electromagnetic noise generated by the operation of the inverter according to the second embodiment.

FIG. 6 is a circuit diagram illustrating a configuration of a temperature detection circuit according to a third embodiment.

FIG. 7 is a diagram illustrating a change in a power supply voltage and a change in a voltage applied to a temperature sensor and a voltage dividing resistor in the third embodiment.

FIG. 8 is a circuit diagram illustrating a configuration of a temperature detection circuit according to a fourth embodiment.

FIG. 9 is a diagram illustrating a relationship among a resistance value of a temperature sensor, a voltage applied to an inductor, and a frequency in the fourth embodiment.

FIG. 10 is a circuit diagram illustrating a configuration of temperature detection circuit according to a fifth embodiment.

FIG. 11 is a circuit diagram illustrating a configuration of a temperature detection circuit according to a sixth embodiment.

FIG. 12 is a diagram illustrating a relationship among a resistance value of a temperature sensor, a voltage applied to the temperature sensor, and a frequency in the sixth embodiment.

### DESCRIPTION OF EMBODIMENTS

Embodiments of the present disclosure will be described below in detail with reference to the drawings. The same or corresponding parts in the drawings are denoted by the same reference signs, and the description thereof will not he repeated in principle.

First Embodiment

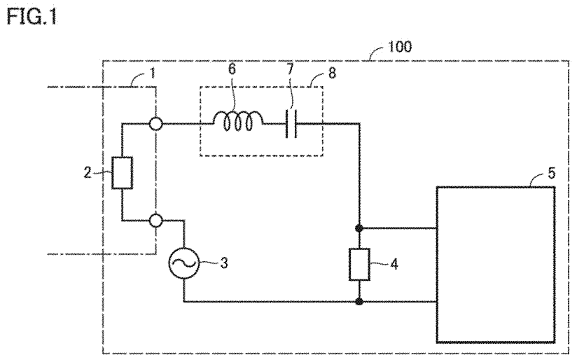

FIG. 1 is a circuit diagram illustrating a configuration of a temperature detection circuit 100 according to the first embodiment. As illustrated in FIG. 1, temperature detection circuit 100 detects the temperature of a power semiconductor 1. Temperature detection circuit 100 includes a temperature sensor 2, an AC power supply 3, a voltage dividing resistor 4, a voltage detection circuit 5, and a resonance circuit 8.

Temperature sensor 2 includes an clement having a resistance value R1 that changes with a change in temperature. Temperature sensor 2 includes, for example, a passive element such as a thermistor whose resistance value changes with a change in temperature. Temperature sensor 2 is mounted inside power semiconductor 1 provided in, for example, a power module and a semiconductor device used for power control of an electric apparatus. Power semiconductor 1 is used, for example, in a power conversion device such as an inverter, AC power supply 3 is connected to one end of temperature sensor 2. Resonance circuit 8 is connected to the other end of temperature sensor 2

AC power supply 3 is configured to supply AC power to temperature sensor AC power supply 3 is configured to output AC power of a predetermined frequency. AC power supply 3 outputs, for example, an AC voltage having a predetermined amplitude V1 as a maximum value. The predetermined frequency is set to coincide with, for example, a resonance frequency in resonance circuit 8 described later.

Resonance circuit 8 is a resonance circuit in which impedance has an extreme value when AC power having the resonance frequency is supplied. In the first embodiment, resonance circuit 8 is an LC series resonance circuit obtained by connecting an inductor 6 and a capacitor 7 in Series with AC power supply 3. Specifically, resonance circuit 8 is formed by connecting one end of inductor 6 and one end of capacitor 7. The other end of inductor 6 is connected to the other end of temperature sensor 2. The other end of capacitor 7 is connected to one end of voltage dividing resistor 4. In resonance circuit 8 described above, the impedance has a minimum value when the AC power of the resonance frequency is supplied. In the first embodiment, a plurality of elements constituting resonance circuit S includes inductor 6 and capacitor 7.

Voltage dividing resistor 4 is a passive element used for calculating the temperature of temperature sensor 2. The other end of voltage dividing resistor 4 is connected to AC power supply 3. Voltage dividing resistor 4 has a predetermined resistance value R2.

Voltage detection circuit 5 is connected in parallel with voltage dividing resistor 4. Voltage detection circuit 5 detects an amplitude V2 of the AC voltage applied to voltage dividing resistor 4. Resistance value R1 of temperature sensor 2 can be calculated using amplitude V2 of the AC voltage detected by voltage detection circuit 5. Note that resistance value R1 of temperature sensor 2 may be calculated, for example, in voltage detection circuit 5 or may he calculated using an arithmetic device (not illustrated). In the first embodiment, a plurality of elements connected to AC power supply 3 includes temperature sensor 2, inductor 6, capacitor 7, and voltage dividing resistor 4. Voltage detection circuit 5 detects a voltage applied to voltage dividing resistor 4 among the plurality of elements connected to AC power supply 3.

For example, since the predetermined frequency of the AC voltage output from AC power supply 3 is set to coincide with the resonance frequency in resonance circuit 8, inductor 6 and capacitor 7 of resonance circuit S cancel out each other's voltage drop due to the resonance phenomenon. As a result, the AC voltage output from AC power supply 3 is apparently divided by temperature sensor 2 and voltage dividing resistor 4.

Therefore, following Formula (1) is established by the voltage divider rule from amplitude V1 of the AC voltage output from AC power supply 3, amplitude V2 of the AC voltage applied to voltage dividing resistor 4, resistance value R1 of temperature sensor 2, and resistance value R2 of voltage dividing resistor 4.

V2=V1×R2/(R1+R2) (1)

Therefore, resistance value R1 can be calculated by following Formula (2) calculated by rearranging Formula (1).

R1=R2×(V1−V2)/V2 (2)

temperature of temperature sensor 2 is acquired using, calculated resistance value R1 and a predetermined relationship between resistance value R1 and the temperature. The predetermined relationship between resistance value R1 and the temperature is indicated by, for example, a map, a function, or the like. The map, the function, or the like is stored in advance in, for example, a memory or the like.

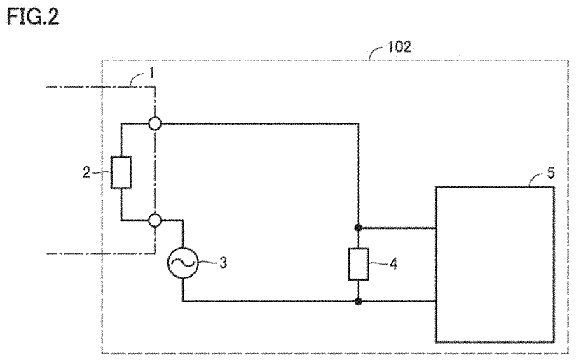

The operation and effects of temperature detection circuit 100 according to the first embodiment having the above-described configuration will be described while being compared with the configuration of a temperature detection circuit 102 illustrated in FIG. 2 as a comparative example with respect to the first embodiment.

FIG. 2 is a circuit diagram illustrating the configuration of temperature detection circuit 102 as a comparative example with respect to the first embodiment

Temperature detection circuit 102 illustrated in FIG. 2 is different from temperature detection circuit 100 illustrated in FIG. 1 in not having resonance circuit 8. Other configurations of temperature detection circuit 102 are the same as the configurations of temperature detection circuit 100 in FIG. 1, and the same components are denoted by the same reference numerals. Therefore, the detailed description will not be repeated.

It is assumed that temperature detection circuit 100 and temperature detection circuit 102 are each mounted on, for example, power semiconductor 1 such as a power conversion device that performs a switching operation at the time of power conversion. It is known that strong electromagnetic noise is generated when the power conversion device using power semiconductor 1 performs a switching operation.

Therefore, when resistance value R1 of temperature sensor 2 is acquired using the voltage divider rule in temperature detection circuit 102 as described above, temperature detection circuit 102 may be affected by electromagnetic noise when acquiring amplitude V2 of the AC voltage applied to voltage dividing resistor 4. As a result, the detection accuracy of temperature detection circuit 102 may deteriorate. To address such a problem, it is conceivable to reduce the influence of a. noise component and improve the noise tolerance by, for example, increasing the AC voltage output from AC power supply 3 which is an external power supply.

However, when the AC voltage output from AC power supply 3 is increased, a temperature rise due to self-heating of temperature sensor 2 increases, which may cause an increase in error of the detection temperature. This is because the power consumption in temperature sensor 2 increases by increasing the AC voltage output from AC power supply 3. an amount of the temperature rise due to the self-heating of temperature sensor 2 increases, and the increased amount of temperature rise is added to the temperature of an object for temperature detection.

Temperature detection circuit 100 illustrated in FIG. 1 further includes resonance circuit 8 in addition to the configuration of temperature detection circuit 102. In addition, the resonance frequency in resonance circuit 8 and the frequency of the AC power are set to coincide with each other.

When resonance circuit 8 is a series resonance circuit, the impedance has the local minimum (minimum) at the resonance frequency. That is, the impedance in a frequency band other than the resonance frequency is larger than the impedance at the resonance frequency. Therefore, even when a noise component in a frequency band other than the resonance frequency is superimposed on the output of the temperature sensor, the influence of the noise component on the detection result is suppressed.

As described above, when the resonance circuit is a series resonance circuit, temperature detection circuit 100 according to the first embodiment can minimize the impedance at the resonance frequency. Therefore, even when a noise component in a frequency band other than the resonance frequency is superimposed on the output of the temperature sensor, it is possible to suppress the influence of the noise component on the detection result. As a result, the noise tolerance can be increased without increasing the output voltage of the AC power. Furthermore, since it is not required to increase the output voltage of the AC power, an increase in error caused by self-heating of the temperature sensor can be suppressed. Therefore, it is possible to provide a temperature detection circuit that suppresses an increase in a temperature detection error caused by self-heating of the temperature sensor.

Note that the resonance frequency of resonance circuit 8 is desirably set to, for example, a frequency different from the frequency band including the frequency of the electromagnetic noise. This can further improve noise tolerance. In addition, the inductance of inductor 6 and the capacitance of capacitor 7 of resonance circuit 8 are desirably set to a set resonance frequency.

(Modification of First Embodiment)

Although the first embodiment has described, as an example, the case where temperature sensor 2 is constituted by a passive element such as a thermistor, temperature sensor 2. may be constituted by an active element such as a diode in which a forward voltage changes according to a temperature change, for example.

Although the first embodiment has described, as an example, the case where components are additionally provided as inductor 6 and capacitor 7, parasitic elements inside and outside power semiconductor 1 may be used, for example.

In addition, although the first embodiment has described, as an example, the case where resonance circuit 8 includes passive elements such as inductor 6 and capacitor 7, resonance circuit i1 may include a known filter (such as a low-pass filter, a high-pass filter, or a band-pass filter) using an active element having an equivalent function.

In addition, although the first embodiment has described, as an example, the case where AC power supply 3 is a voltage source capable of supplying a constant voltage, AC power supply 3 may be a current source capable of supplying a constant current.

In addition, although the first embodiment has described, as an example, the case where temperature sensor 2 is mounted inside power semiconductor temperature sensor 2 may be mounted outside power semiconductor 1, and the object for temperature detection is not particularly limited to power semiconductor 1.

Note that all or some of the modifications described a above may be appropriately combined and implemented.

Second Embodiment

The first embodiment has described, as an example, the case, where temperature sensor 2 is mounted on power semiconductor 1. On the other hand, the second embodiment will describe a configuration of an inverter and a specific method for setting a resonance frequency in resonance circuit 8 in a case where power semiconductor 1 is used as a switching device of the inverter which is a power conversion device.

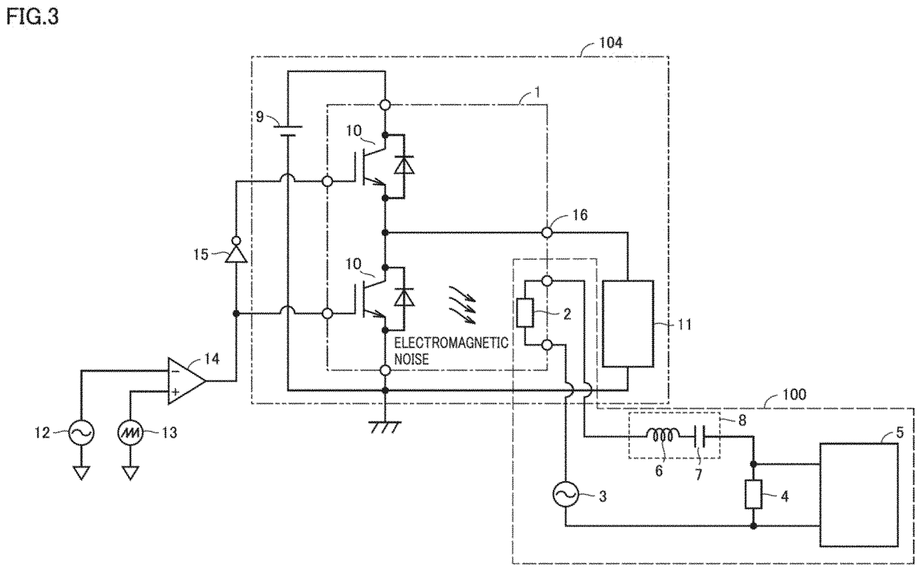

FIG. 3 is a circuit diagram illustrating a configuration of an inverter 104 equipped with temperature detection circuit 100 according to the second. embodiment.

As illustrated in FIG. 3, inverter 104 is a single-phase inverter and includes power semiconductor 1 and a DC high-voltage power supply 9. Inverter 104 converts a DC voltage supplied from DC high-voltage power supply 9 into an AC voltage using power semiconductor 1 and outputs the AC voltage to a load 11. Note that temperature detection circuit 100 illustrated in FIG. 3 has the same configuration as temperature detection circuit 100 illustrated in FIG. 1. The same components are denoted by the same reference numerals. Therefore, the detailed description will not be repeated.

Power semiconductor 1 is a power module including two insulated gate bipolar transistors (IGBIs) 10 and an inverter output terminal 16. A free wheeling diode (FWD) is connected antiparallel to each of two IGBTs 10.

Each of two IGBTs 10 performs a switching operation according to an input of a command signal to a gate electrode. The command signal for each of two IGBTs 10 is generated by a modulation wave command device 12, a carrier wave command device 13, a comparator 14, and an inverting device 15.

Modulation wave command device 12 outputs a modulation wave indicating an operating frequency of inverter 104. Carrier wave command device 13 outputs a triangular wave. Comparator 14 compares the heights of the modulation wave output from modulation wave command device 12 and the triangular wave output from carrier wave command device 13. Comparator 14 outputs an ON signal when the modulation wave is higher than the triangular wave, and outputs an OFF signal when the modulation wave is lower than the triangular wave, for example. Inverting device 15 inverts the signal output from comparator 14. That is, in inverting device 15, the output period of the ON signal among the signals output from comparator 14 is the output period of the OFF signal, and the output period of the OFF signal is the output period of the ON signal.

A signal (positive logic) output from comparator 14 is input as a command signal to the gate electrode of one of two IGBTs 10. A signal (negative logic) output from inverting device 15 is input as a command signal to the gate electrode of the other of two IGBTs 10.

Inverter 104 supplies AC power obtained from inverter output terminal 16 to load 11 by the switching operation of two IGBTs 10 according to the above-described command signal.

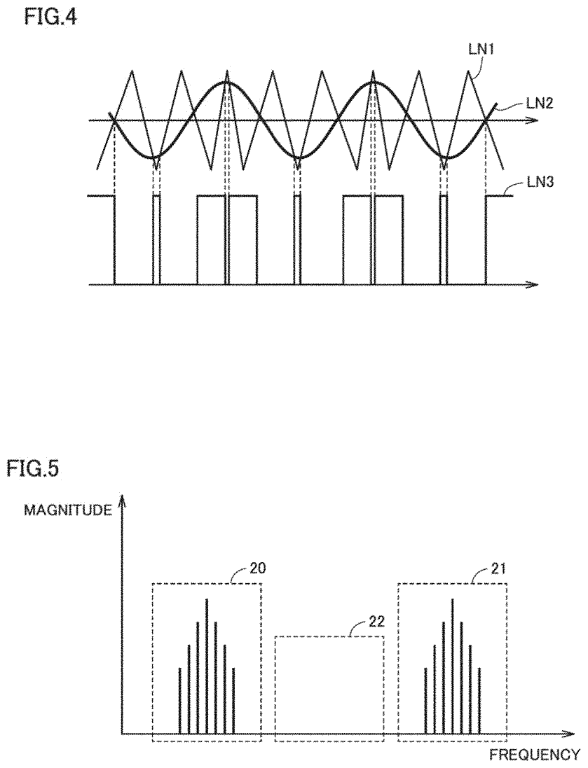

FIG. 4 is a diagram for describing the operation of inverter 104 of the second embodiment. I,N1 in FIG. 4 indicates an example of a waveform of a modulation wave. 11,N2 in FIG. 4 indicates an example of a waveform of a triangular wave. LN3 in FIG. 4 indicates a change in the output voltage of inverter 104.

The modulation wave indicated by LN1 in FIG. 4 Output from modulation wave command device 12 is compared with the carrier wave indicated by LN2 in FIG. 4 output from carrier wave command device 13 in comparator 14, and when the magnitude of the carrier wave is larger than the magnitude of the modulation wave, the output voltage of inverter 104 becomes positive as indicated by LN3 in FIG. 4. When the magnitude of the carrier wave is smaller than the magnitude of the modulation wave, the output voltage of inverter 104 becomes 0.

As described above, the operation of inverter 104 is established by the magnitude relationship between the modulation wave and the carrier wave, and the frequency generated by the operation of inverter 104 is determined by the frequency of the modulation wave and the frequency of the carrier wave.

FIG. 5 is a diagram illustrating a frequency spectrum of electromagnetic noise generated by the operation of inverter 104 according to the second embodiment.

The frequency spectrum of the electromagnetic noise. includes a spectrum having a certain magnitude due to a carrier wave in a frequency band near an integral multiple order of the modulation wave. For example, FIG. 5 illustrates a first frequency band 20 near the frequency n times the modulation wave and a second frequency band 21 near the frequency n+1times the modulation wave.

In this case, a third frequency band 22 between first frequency hand 20 and second frequency band 21 is a frequency band in which no electromagnetic noise is generated. Therefore, by setting the resonance frequency of resonance circuit 8 of temperature detection circuit 100 and the frequency of AC power supply 3 within third frequency hand 22, it is possible to select while avoiding the frequency band in which the influence of the electromagnetic noise is dominant. For example, the inductance of inductor 6 and the capacitance of capacitor 7 in resonance circuit 8 are set such that the resonance frequency in resonance circuit 8 falls within third frequency band 22. The inductance of inductor 6 and the capacitance of capacitor 7 in resonance circuit may be set in design, or may be set by being experimentally adapted.

That is, inductor 6 or capacitor 7 constituting resonance circuit S exhibits high impedance with respect to the electromagnetic noise generated in first frequency hand 20 and second frequency band 21, so that the electromagnetic noise generated by the operation of power semiconductor I can be prevented from being applied to voltage detection circuit 5. On the other hand, the AC voltage applied from AC power supply 3 to voltage detection circuit 5 has a frequency coinciding with the resonance frequency, so that the tolerance to electromagnetic noise can he further increased, as compared with temperature detection circuit 100 according to the first embodiment. Therefore, it is not necessary to increase the voltage and the current generated in AC power supply 3 in order to improve the noise tolerance, so that self-heating of temperature sensor 2 can he suppressed, Furthermore, for example, by setting the voltage and current generated in AC power supply 3 to be smaller by an amount corresponding to an increase in tolerance to electromagnetic noise, self-heatim4can reduced, and the detection error can be reduced.

(Modification of Second Embodiment)

Although the second embodiment has described the case in which power semiconductor 1 includes two IGBTs 10, power semiconductor 1 may include another active element such as a metal-oxide-semiconductor field-effect transistor (MOSFET) instead of IGBT 10.

In addition, although the second embodiment has described, as an example, the case where power semiconductor 1 is applied to a single-phase inverter, power semiconductor 1 can be applied to various power conversion devices.

In addition, although the second embodiment has described, as an example, the case where temperature sensor 2 is constituted by a passive element such as a thermistor as in the first embodiment, temperature sensor 2 may be constituted by an in active element such as a diode in which a forward voltage changes according to a temperature change, for example.

In addition, although the second embodiment has described, as an example, the case where components are additionally provided as inductor 6 and capacitor 7 as in the first embodiment, parasitic elements inside and outside power semiconductor I may be used, for example.

In addition, although the second embodiment has described, as an example, the case where resonance circuit 8 includes passive elements such as inductor 6 and capacitor 7 as in the first embodiment, resonance circuit 8 may include a known filter using an active element having an equivalent function.

In addition, although the second embodiment has described, as an example, the case where AC power supply 3 is a voltage source capable of supplying a constant voltage as in the first embodiment, AC power supply 3 may be a current source capable of supplying a constant current.

In addition, although the second embodiment has described, as an example, the ease where temperature sensor 2 is mounted inside power semiconductor 1 as in the first embodiment, temperature sensor 2 may be mounted outside power semiconductor 1, and the object for temperature detection is not particularly limited to power semiconductor 1.

Note that all or some of the modifications described above may e appropriately combined and implemented.

Third Embodiment

The above first embodiment has described, as an example, the case where AC power supply 3 is used as the power supply. On the other hand, the third embodiment TU will describe the configuration and operation of a temperature detection circuit in a case where a half-bridge inverter power supply 23 is used as the power supply.

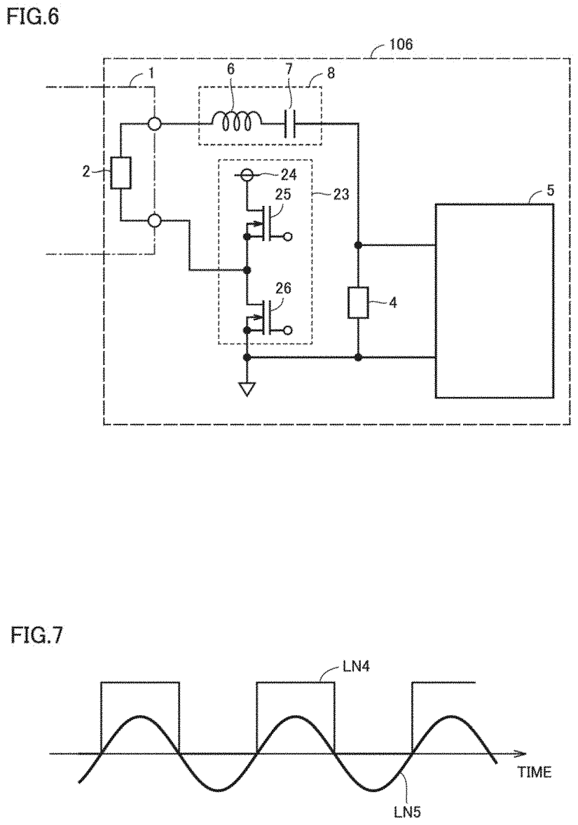

FIG. 6 is a circuit diagram illustrating a configuration of a temperature detection circuit 106 according to the third embodiment. Temperature detection circuit 106 illustrated in FIG. 6 is different from temperature detection circuit 100 illustrated in FIG. 1 in having half-bridge inverter power supply 23 instead of AC power supply 3. The other configurations are similar to those of temperature detection circuit 100 illustrated in FIG. 1. The same components are denoted by the same reference numerals. Therefore, the detailed description will not be repeated.

Hall-bridge inverter power supply 23 includes, fix example, a DC power supply 24 and two MOSFETs 25 and 26. DC power supply 24 is connected to a drain of MOSFET 25. A source of MOSFET 25 and a drain of MOSFET 26 are connected, and one end of temperature sensor 2 is connected between the source of MOSFET 25 and the drain of MOSFET 26. The other end of voltage dividing resistor 4 is connected to a source of MOSFET 26. Two MOSFETs 25 and 26 are switched between a first state in which one of MOSFETs 25 and 26 is turned on and the other is turned off and a second state in which the one of them is turned off and the other is turned on, The frequency of the switching operation is set to coincide with the resonance frequency of resonance circuit 8. Half-bridge inverter power supply 23 outputs a voltage waveform including a rectangular wave by the switching operation.

FIG. 7 is a diagram illustrating a change in power supply voltage and a change in voltage applied to temperature sensor 2 and voltage dividing resistor 4 in the third embodiment. LN4 in FIG. 7 indicates an example of a change in the output voltage of half-bridge inverter power supply 23. LNS in FIG. 7 indicates an example of a change in voltage applied to temperature sensor 2 and voltage dividing resistor 4.

As indicated by LN4 in FIG. 7, when two MOSFETs 25 and 26 are switched, a. state in which the voltage of DC power supply 24 is output and a state in which the voltage is 0 arc alternately switched. As the output voltage of half-bridge inverter power supply 23, only the voltage of a fundamental frequency (resonance frequency) component is extracted by resonance circuit 8, Therefore, as indicated by LN5 in FIG. 7, the waveform of the voltage applied to temperature sensor 2 and voltage dividing resistor 4 is sinusoidal.

Thus, when resonance circuit 8 is a series resonance circuit, the impedance has the local minimum (minimum) at the resonance frequency. That is, the impedance in a frequency band other than the resonance frequency is larger than the impedance at the resonance frequency. Therefore, even when a noise component in a frequency band other than the resonance frequency is superimposed on the output of the temperature sensor, the influence of the noise component on the detection result is suppressed,

Thus, even when a noise component in a frequency band other than the resonance frequency is superimposed on the output of temperature sensor 2, temperature detection circuit 106 according to the third embodiment can suppress the influence of the noise component on the detection result. As a result, the noise tolerance can be increased without increasing the output voltage of the AC power. Furthermore, since it is not required to increase the output voltage of the AC power, an increase in error caused by self-heating of the temperature sensor can be suppressed. Therefore, it is possible to provide a temperature detection circuit that suppresses an increase in a temperature detection error caused by self-heating of the temperature sensor.

Furthermore, when the power supply voltage is set to have a rectangular wave, the voltage applied to temperature sensor 2 and voltage dividing resistor 4 is larger than the amplitude of the output voltage of half-bridge inverter power supply 23, so that the output voltage of half-bridge inverter power supply 23 can be made smaller than the voltage of AC power supply 3 used in the first embodiment.

(Modification of Third Embodiment)

Although the third embodiment has described, as an example, the case where MOSFETs 25 and 26 are used as the semiconductor constituting half-bridge inverter power supply 23, half bridge inverter power supply 23 may include, for example, another active element such as a bipolar transistor.

In addition, although the third embodiment has described, as an example, the case where temperature sensor 2 is constituted by a passive element such as a thermistor as in the fin it embodiment, temperature sensor 2 may be constituted by an active element such as a diode in which a forward voltage changes according to a temperature change, for example.

In addition, although the third embodiment has described, as an example, the case where components arc additionally provided as inductor 6 and capacitor 7 as in the first embodiment, parasitic elements inside and outside power semiconductor 1 may be used, for example.

In addition, although the third embodiment has described, as an example, the case where resonance circuit $ includes passive elements such as inductor 6 and capacitor 7 as in the first embodiment, resonance circuit 8 may include a known filter using an active clement having an equivalent function.

In addition, although the third embodiment has described, as an example, the case where temperature sensor 2 is mounted inside power semiconductor 1 as in the first embodiment, temperature sensor 2 may be mounted outside power semiconductor 1, and the object for temperature detection is not particularly limited to power semiconductor 1.

Note that all or some of the modifications described above may be appropriately combined and implemented.

Fourth Embodiment

The above first embodiment has described the configuration and operation of temperature detection circuit 100 capable of detecting the temperature from resistance value R1 of temperature sensor 2 calculated using the voltage divider rule in the circuit configuration including temperature sensor 2 and voltage dividing resistor 4. On the other hand, the fourth embodiment will describe the configuration and operation of a temperature detection circuit that detects the temperature using an amount of voltage drop in inductor 6 of resonance circuit 8.

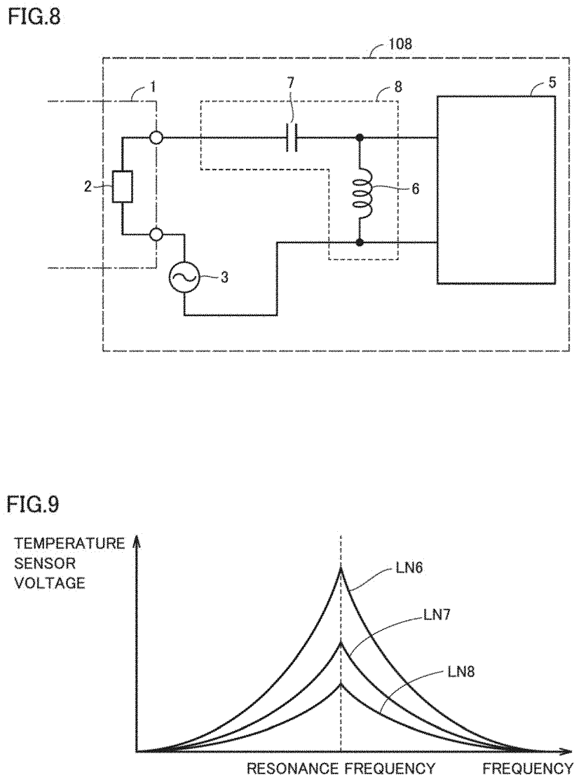

FIG. 8 is a circuit diagram illustrating the configuration of a temperature detection circuit 108 according to the fourth embodiment. Temperature detection circuit 108 illustrated in FIG. 8 is different from temperature detection circuit 100 illustrated in FIG. 1 in that temperature detection circuit 108 does not include voltage dividing resistor 4 and voltage detection circuit 5 detects the voltage applied to inductor 6 of resonance circuit 8. The other configurations are similar to those of temperature detection circuit 100 illustrated in FIG. 1. The same components are denoted by the same reference numerals. Therefore, the detailed description will not be repeated.

As illustrated in FIG. 8, voltage detection circuit 5 is connected in parallel with inductor 6. In the fourth embodiment, a plurality of elements connected to AC power supply 3 includes temperature sensor 2, inductor 6, and capacitor 7. Voltage detection circuit 5 detects a voltage applied to inductor 6 among the plurality of elements connected to AC power supply 3. The voltage detected by voltage detection circuit 5 indicates an amount of voltage drop in inductor 6, and varies depending on resistance value R1 of temperature sensor 2. Therefore, the temperature of temperature sensor 2 can be detected from the amount of voltage drop by, for example, preparing a map or the like which indicates the relationship between the amount of voltage drop in inductor 6 and resistance value R1 or the relationship between the amount of voltage drop and the temperature and which is adapted through experiments or the like. 00721 FIG. 9 is a diagram illustrating a relationship among resistance value R i of temperature sensor 2, a voltage applied to inductor 6, and a frequency in the fourth embodiment. LN6 in FIG. 9 indicates the relationship between the voltage applied to inductor 6 and the frequency when resistance value R1 of temperature sensor 2 is Ra. LN7 in FIG. 9 indicates the relationship between the voltage applied to inductor 6 and the frequency when resistance value R1 of temperature sensor 2 is Rb(>Ra). LN8 in FIG. 9 indicates the relationship between the voltage applied to inductor 6 and the frequency when resistance value R1 of temperature sensor 2 is Re (>Rh).

As illustrated in FIG. 9, the impedance of resonance circuit 8 is minimized at the resonance frequency when resistance value R1 of temperature sensor 2 is any of Ra. Rb, and Re, so that the voltage applied to inductor 6 is maximized.

As illustrated in FIG. 9, the amount of voltage drop (LN6 in FIG. 9) in inductor 6 at the resonance frequency when resistance value R1 of temperature sensor 2 is Rn is larger than the amounts of voltage drop when resistance value R1 of temperature sensor 2 is Rb and when resistance value R1 of temperature sensor 2 is Re,

in addition, the amount of voltage drop in inductor 6 at the resonance frequency when resistance value R1 of temperature sensor 2 is Rb is larger than the amount of voltage drop when resistance value R1 of temperature sensor 2 is Re.

In addition, the amount of voltage drop in inductor 6 at the resonance frequency when resistance value R1 of temperature sensor 2 is Re is smaller than the amount of voltage drop when resistance value R1 of temperature sensor 2 is Ra and when resistance value R1 of temperature sensor 2 is Rh.

As illustrated in FIG. 9, there is a correlation between the amount of voltage drop in inductor 6 and resistance value R1 of temperature sensor 2. Therefore, resistance value R1 of temperature sensor 2 can be detected from the amount of voltage drop by preparing a map or the like which indicates the relationship between the amount of voltage drop in inductor 6 and the resistance value and which is adapted through experiments or the like. Thus, the temperature of temperature sensor 2 can he calculated from resistance value R1 of temperature sensor 2 using the map or the like. Alternatively, the temperature of temperature sensor 2 may be detected from the amount of voltage drop by preparing a map or the like which indicates the relationship between the amount of voltage drop in inductor 6 and the temperature of temperature sensor 2 and which is adapted through experiments or the like.

In addition, the difference in amount of voltage drop in inductor 6 at the resonance frequency is larger than that in other frequency bands, so that the temperature detection accuracy can be further improved by comparing the amounts of voltage drop at the resonance frequency.

Furthermore, voltage dividing resistor 4 can be eliminated, whereby the temperature detection circuit according to the present embodiment can be further downsized, as compared with the temperature detection circuit according to the first embodiment.

(Modification of Fourth Embodiment)

Although the fourth embodiment has described, as an example, the case where temperature sensor 2 is constituted by a passive element such as a thermistor as in the first embodiment, temperature sensor 2 may be constituted by an active clement such as a diode in which a forward voltage changes according to a temperature change, for example.

In addition, although the fourth embodiment has described, as an example, the case where components are additionally provided as inductor 6 and capacitor 7 as in the first embodiment, parasitic elements inside and outside power semiconductor 1 may be used, for example.

In addition, although the fourth embodiment has described, as an example, the case where AC power supply 3 is a voltage source capable of supplying a constant voltage as in the first embodiment, AC power supply 3 may be a current source capable of supplying a constant current.

In addition, although the fourth embodiment has described, as an example, the case where temperature sensor 2 is mounted inside power semiconductor 1 as in the first embodiment, temperature sensor 2 may be mounted outside power semiconductor 1, and the object for temperature detection is not particularly limited to power semiconductor 1.

Note that all or some of the modifications described above may be appropriately combined and implemented.

Fifth Embodiment

The above first embodiment has described the configuration and operation of temperature detection circuit 100 capable of detecting the temperature from the resistance value of temperature sensor 2 calculated using the voltage divider rule in the circuit configuration including temperature sensor 2 and voltage dividing resistor 4. On the other hand, the fifth embodiment will describe the configuration and operation of a temperature detection circuit that detects the temperature using an amount of voltage drop in capacitor 7 of resonance circuit 8.

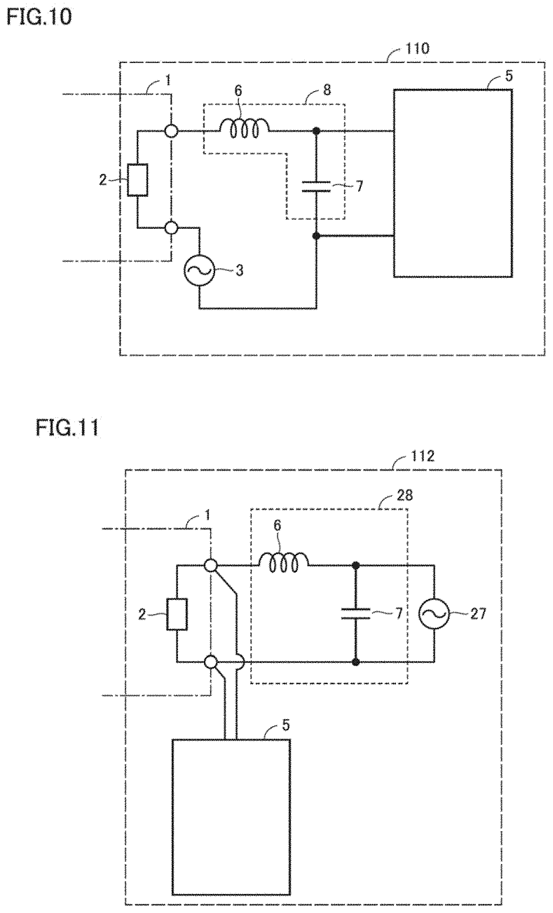

FIG. 10 is a circuit diagram illustrating the configuration of a temperature detection circuit 110 according to the fifth embodiment. Temperature detection circuit lit) illustrated in FIG. 10 is different from temperature detection circuit 100 illustrated in FIG. 1 in that: temperature detection circuit 110 does not include voltage dividing resistor 4: voltage detection circuit 5 detects the voltage applied to capacitor 7 of resonance circuit 8; and the positions of inductor 6 and capacitor 7 are inverted. The other configurations are similar to those of temperature detection circuit 100 illustrated in FIG. 1. The same components are denoted by the same reference numerals. Therefore, the detailed description will not be repeated.

As illustrated in FIG. 10, voltage detection circuit 5 is connected in parallel with capacitor 7. in the filth embodiment, a plurality of elements connected to AC power supply 3 includes temperature sensor 2, inductor 6, and capacitor 7. Voltage detection circuit 5 detects a voltage applied to capacitor 7 among the plurality of elements connected to AC power supply 3. The voltage detected by voltage detection circuit 5 indicates an amount of voltage drop in capacitor 7, and varies depending on resistance value R1 of temperature sensor 2. Therefore, the temperature of temperature sensor 2 can be detected from the amount of voltage drop by, for example, preparing a map or the like which indicates the relationship between the amount of voltage drop in capacitor 7 and resistance value R1 or the relationship between the amount of voltage drop and the temperature and which is adapted through experiments or the like.

The relationship among resistance value R1 of temperature sensor 2, the voltage applied to capacitor 7, and the frequency in the fifth embodiment is similar to the relationship among resistance value R1 of temperature sensor 2, the voltage applied to inductor 6, and the frequency in the fourth embodiment illustrated in FIG. 9.

Therefore, the detailed description will not be repeated.

With this configuration, since there is a correlation between the amount of voltage drop in capacitor 7 and resistance value R1 of temperature sensor 2, resistance value R1 of temperature sensor 2 can be detected from the amount of voltage drop by preparing the map or the like which indicates the relationship between the amount of voltage drop in capacitor 7 and resistance value R1 and which is adapted through experiments or the like. Thus, the temperature of temperature sensor 2 can be calculated from resistance value R1 of temperature sensor 2 using the map or the like. Alternatively, the temperature of temperature sensor 2 may be detected from the amount of voltage drop by preparing the map or the like which indicates the relationship between the amount of voltage drop in capacitor 7 and the temperature of temperature sensor 2 and which is adapted through experiments or the like,

In addition, the difference in amount of voltage drop in capacitor 7 at the resonance frequency is larger than that in other frequency bands, so that the temperature detection accuracy can be further improved by comparing the amounts of voltage drop at the resonance frequency.

Furthermore, voltage dividing resistor 4 can be eliminated, whereby the temperature detection circuit according to the present embodiment can be further downsized, as compared with the temperature detection circuit according to the first embodiment.

In addition, temperature detection circuit 110 according to the fifth embodiment has an effect that capacitor 7 bypasses a signal (noise component) in a frequency band higher than the resonance frequency. Therefore, in a. ease where voltage detection circuit 5 is configured by it digital circuit or in a case where the circuit that processes the output of voltage detection circuit 5 is configured by a digital circuit, aliasing can be prevented.

(Modification of Fifth Embodiment)

Although the fifth embodiment has described, as an example, the case where temperature sensor 2 is constituted by a passive element such as a thermistor as in the first embodiment, temperature sensor 2 may be constituted by an active element such as a diode in which a forward voltage changes according to a temperature change, for example.

In addition, although the fifth embodiment has described, as an example, the case where components are additionally provided as inductor 6 and capacitor 7 as in the first embodiment, parasitic elements inside and outside power semiconductor I. may be used, for example.

In addition, although the fifth embodiment has described, as an example, the case where AC power supply 3 is a voltage source capable of supplying a constant voltage as in the first embodiment, AC power supply 3 may he a current source capable of supplying a constant current.

In addition, although the fifth embodiment has described, as an example, the case where temperature sensor 2 is mounted inside power semiconductor I as in the first embodiment, temperature sensor 2 may be mounted outside power semiconductor 1, and the object for temperature detection is not particularly limited to power semiconductor 1.

Note that all or some of the modifications described above may be appropriately combined and implemented.

Sixth Embodiment

The above first to fifth embodiments have described, as art example, the case where resonance circuit 8 is a series resonance circuit. On the other hand, the sixth embodiment will describe the configuration and operation of a temperature detection circuit in a case where resonance circuit 8 is a parallel resonance circuit instead of a series resonance circuit.

FIG. 11 is a circuit diagram illustrating the configuration of a temperature detection circuit 112 according to the sixth embodiment. Temperature detection circuit 112 illustrated in FIG. 11 includes temperature sensor 2, voltage detection circuit 5, an AC power supply 27 and a resonance circuit 28.

Temperature sensor 2 has a configuration similar to that of temperature sensor 2 described in the first embodiment. Therefore, the detailed description will not he repeated.

Voltage detection circuit 5 is connected in parallel with temperature sensor 2. Voltage detection circuit 5 detects an amplitude V3 of an AC voltage applied to temperature sensor 2. In the sixth embodiment, a plurality of elements connected to AC power supply 3 includes temperature sensor 2, inductor 6, and capacitor 7. Voltage detection circuit 5 detects a voltage applied to temperature sensor 2 among the plurality of elements connected to AC power supply 3.

Resonance circuit 28 is a resonance circuit in which impedance has an extreme value when AC power having a resonance frequency is supplied. in the sixth embodiment, resonance circuit 28 is an LC: parallel resonance circuit obtained by connecting inductor 6 and capacitor 7 in parallel with AC power supply 27. Specifically, resonance circuit 28 is formed by connecting one end of inductor 6 and one end of capacitor 7. The other end of inductor 6 is connected to the other end of temperature sensor 2. The other end of capacitor 7 is connected to one end of temperature sensor 2. AC power supply 27 is connected to a connection point between inductor 6 and capacitor 7 and the other end of capacitor 7. In resonance circuit 28 described above, the impedance has a maximum value when the AC power of the resonance frequency is supplied. In the sixth embodiment, a plurality of elements constituting resonance circuit 8 includes inductor 6 and capacitor 7.

AC power supply 27 is configured to supply AC power to temperature sensor 2. AC power supply 27 can vary the frequency.

Temperature detection circuit 112 illustrated in FIG. 11 has a characteristic that the resonance frequency in resonance circuit 28 changes when the resistance value of temperature sensor 2 changes. More specifically, as the resistance value. of temperature sensor 2 increases, the resonance frequency in temperature detection circuit 112 decreases. As the resistance value of temperature sensor 2 decreases, the resonance frequency in temperature detection circuit 112 increases. This is because temperature sensor 2 and inductor 6 are connected in series with AC power supply 27.

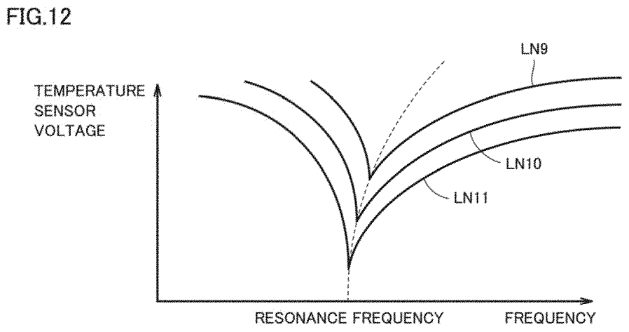

FIG. 12 is a diagram illustrating a relationship among resistance value R1 of temperature sensor 2, a voltage applied to temperature sensor 2, and a frequency in the sixth embodiment. LN9 in FIG. 12 indicates the relationship between the voltage applied to temperature sensor 2 and the frequency when resistance value R1 of temperature sensor 2 is Rd. LN10 in FIG. 12 indicates the relationship between the voltage applied to temperature sensor 2 and the frequency when resistance value R1 of temperature sensor 2 is Re (>Rd). LN11 in FIG. 12 indicates the relationship between the voltage applied to temperature sensor 2 and the frequency when resistance value R1 of temperature sensor 2 is Rf (>Re).

As illustrated in FIG. 12, the impedance of resonance circuit 28 is maximized at the resonance frequency when resistance value R1 of temperature sensor 2 is any of Rd, Re, and Rf, so that the voltage applied to temperature sensor 2 is minimized. In this case, as resistance value R1 of temperature sensor 2 decreases, the frequency resonance frequency) at which the voltage applied to temperature sensor 2 is minimized and the extreme value increase, as indicated by LN9, LN10, and LN11 in FIG. 12. As resistance value R1 of temperature sensor 2 increases, the resonance frequency and the extreme value decrease (see the broken line in FIG. 12).

That is, there is a correlation between the resonance frequency and the temperature. Therefore, the temperature of temperature sensor 2 can be detected from the resonance frequency by preparing a map or the like which indicates the relationship between the resonance frequency and the temperature and which is adapted through experiments or the like,

Therefore, for example, the frequency of the AC voltage output from AC power supply 27 is changed to specify the extreme value of the voltage detected by voltage detection circuit 5. The frequency corresponding to the specified extreme value is specified as the resonance frequency. The temperature of temperature sensor 2 can be detected using the specified resonance frequency and the above-described map.

(Modification of Sixth Embodiment)

The sixth embodiment has described the case where the resonance frequency at which the voltage applied to temperature sensor 2 is minimized is specified, and the temperature of temperature sensor 2 is detected from the map or the like indicating the relationship between the specified resonance frequency and temperature. However, since there is a correlation between the minimum voltage value and the temperature, the temperature of temperature sensor 2 can be detected from the minimum value by preparing a map or the like which indicates the relationship between the minimum value and the temperature and which is adapted through experiments or the like,

Therefore, for example, the frequency of the AC voltage output from AC power supply 27 is changed to specify the extreme value of the voltage detected by voltage detection circuit 5. The temperature of temperature sensor 2 can he detected using the specified extreme value and the above-described map.

In addition, although the sixth embodiment has described, as an example, the case where resonance circuit 28 includes passive elements such as inductor 6 and capacitor 7, resonance circuit 28 may include a known filter using an. active element having an equivalent function.

In addition, a although the sixth embodiment has described, as an example, the case where AC power supply 27 is a voltage source capable of supplying a constant voltage, AC power supply 27 may be a current source capable of supplying a constant current.

In addition, although the sixth embodiment has described, as an example, the case where temperature sensor 2 is constituted by a passive element such as a thermistor as in the first embodiment, temperature sensor 2 may be constituted by an active element such as a diode in which a forward voltage changes according to a temperature change, for example.

In addition, although the sixth embodiment has described, as an example, the case where components are additionally provided as inductor 6 and capacitor 7 as in the first embodiment, parasitic elements inside and outside power semiconductor 1 may be used, for example,

In addition, although the sixth embodiment has described as an example, the case where temperature sensor 2 is mounted inside power semiconductor 1 as in the first embodiment, temperature sensor 2 may be mounted outside power semiconductor 1, and the object for temperature detection is not particularly limited to power semiconductor 1.

Note that all or some of the modifications described, above may be appropriately combined and implemented.

It should be understood that the embodiments disclosed herein are illustrative in all respects and not restrictive. The scope of the present disclosure is defined not by the above description but by the claims, and is intended to include meanings equivalent to the claims and all modifications within the scope.

### REFERENCE SIGNS LIST

1: power semiconductor, 2: temperature sensor, 3, 27: AC power supply, 4: voltage dividing resistor, 5: voltage detection circuit, 6: inductor, 7: capacitor, 8, 28: resonance circuit, 9: DC high-voltage power supply, 10: 1GBT, 11: load, 12: modulation wave command device, 13: carrier wave command device, 14: comparator, 15: inverting device, 16: inverter output terminal, 20: first frequency band, 2 I : second frequency hand, 22: third frequency band, 23: half-bridge inverter power supply, 24: DC power supply, 25, 26: MOSFET, 100, 102, 106, 108, 110, 112: temperature detection circuit, 104: inverter

1. A temperature detection circuit comprising:
a temperature sensor having a resistance value that changes according to a change in temperature;
an AC power supply to supply AC power to the temperature sensor;
a resonance circuit connected to the temperature sensor, the resonance circuit having an impedance that has an extreme value when AC power having a resonance frequency is supplied;
a voltage dividing resistor connected in series with the resonance circuit and
a voltage detection circuit to detect a voltage applied to any of a plurality of elements connected to the AC power supply and detect a temperature of the temperature sensor using the detected voltage, wherein
the resonance frequency in the resonance circuit and a frequency of the AC power are set to coincide with each other,
the resonance circuit includes a series resonance circuit in which a plurality of elements constituting the resonance circuit is connected in series with the AC power supply,
the voltage detection circuit is connected in parallel with the voltage dividing resistor,
the resonance circuit includes an inductor and a capacitor,
the inductor and the capacitor are connected in series with the AC power supply, and
the voltage detection circuit is connected in parallel with the inductor.

2.-4. (canceled)

5. The temperature detection circuit according to claim 1, wherein
the inductor and the capacitor are connected in series with the AC power supply, and
the voltage detection circuit is connected in parallel with the capacitor.

6. The temperature detection circuit according to claim 1, wherein the AC power supply outputs a voltage waveform including a rectangular wave.

7. The temperature detection circuit according to claim 1, wherein
the resonance circuit includes a parallel resonance circuit in which a plurality of elements constituting the resonance circuit is connected in parallel with the AC power supply, and
the voltage detection circuit is connected in parallel with the temperature sensor.

8. The temperature detection circuit according to claim 7, wherein the resonance circuit includes an inductor and a capacitor.

9. The temperature detection circuit according to claim 7, wherein
the AC power supply varies the frequency of the AC power, and
the voltage detection circuit sets the frequency of the AC power at which the detected voltage has an extreme value as the resonance frequency, and detects the temperature of the temperature sensor using either the extreme value or the resonance frequency.

10. The temperature detection circuit according to claim 1, wherein
the temperature sensor is mounted on a power semiconductor, and
the AC power supply outputs the AC power having a frequency different from a frequency of electromagnetic noise generated by operation of the power semiconductor.
